(19) United States
(12) Patent Application Publication
(10) Pub. No.: US 2024/0302891 A1
(43) Pub. Date: Sep. 12, 2024

(54) EMOTION INDUCTION APPARATUS, EMOTION INDUCTION METHOD AND PROGRAM

(71) Applicant: NIPPON TELEGRAPH AND TELEPHONE CORPORATION, Tokyo (JP)

(72) Inventors: Mana SASAGAWA, Tokyo (JP); Shunichi SEKO, Tokyo (JP)

(21) Appl. No.: 18/573,746

(22) PCT Filed: Jun. 30, 2021
(86) PCT No.: PCT/JP2021/024867

§ 371 Date: Dec. 22, 2023

(51) Int. Cl. G06F 3/01; G06V 40/16

(52) U.S. Cl. CPC G06F 3/011; G06V 40/175; G06F 2203/011

(57) ABSTRACT

An emotion induction device that displays an anthropomorphic agent to a human, the emotion induction device including an emotion estimation unit that estimates an emotion of the human, an emotion calculation unit that calculates a specific emotion that is an emotion between an emotion of the human and an induction target emotion that is a target emotion desirably obtained by induction of an emotion of the human, an anthropomorphic agent number calculation unit that calculates a number of anthropomorphic agents having an expression indicating the specific emotion, and a video control unit that displays anthropomorphic agents having an expression indicating the specific emotion to the human by a number calculated by the anthropomorphic agent number calculation unit.

### TECHNICAL FIELD

The present invention relates to a technology for inducing an emotion of a human to another emotion by displaying an anthropomorphic agent.

### BACKGROUND ART

An attempt has been made to guide a situation in a desired direction in a video chat or the like by adjusting the number of persons present using an avatar (Non Patent Literature 1). Furthermore, for example, there is a technology in which pseudo group pressure is generated and the atmosphere of a place is changed by an anthropomorphic agent being caused to be present in a video conference (Non Patent Literature 2). The reason why the atmosphere of a place can be changed in this manner is considered to be that an emotion of a human present is induced by an emotion expressed by an anthropomorphic agent.

### CITATION LIST

### Non Patent Literatures

Non Patent Literature 1: Seta, K., Yokoyama, M., Yoshida, S., Narumi, T., Tanikawa, T., & Hirose, M. (2018 December). Divided Presence: Improving Group Decision-Making via Pseudo-Population Increase. In Proceedings of the 6th International Conference on Human-Agent Interaction (pp. 260-268).
Non Patent Literature 2: Daisuke Katagami. (2011). Group Agent That Misleads People ˜Attempt of Group Pressure Generation by Anthropomorphic Agent ˜. Proceedings of the Annual Conference of JSAI, 25, 1-3.
Non Patent Literature 3: J. A. Russell, “A circumplex model of affect.” Journal of personality and social psychology, vol. 39, no. 6, p. 1161, 1980.
Non Patent Literature 4: Reiko Aruga, Junji Watanabe, and Tadashi Nunobiki: Impression Evaluation of Expression of Emotion of Agent by Expansion and Contraction of Figure, Proceedings of Human Interface Symposium 2017 (2017).

### SUMMARY

### Technical Problem

However, when an emotion desirably obtained by induction (emotion that is an induction target) and an emotion of a human are too far from each other, the target emotion may be difficult to be obtained by induction. For example, it is considered difficult for a human to immediately feel happy in a case where an anthropomorphic agent has a full smile when the human feels angry.

The present invention has been made in view of the above points, and an object of the present invention is to provide a technology for inducing an emotion of a human to a target emotion by an anthropomorphic agent, the technology enabling easy induction to the target emotion even in a case where the target emotion desirably obtained by induction and the emotion of the human are far from each other.

### Solution to Problem

According to the disclosed technology, there is provided an emotion induction device that displays an anthropomorphic agent to a human, the emotion induction device including:
an emotion estimation unit that estimates an emotion of the human,
an emotion calculation unit that calculates a specific emotion that is an emotion between an emotion of the human and an induction target emotion that is a target emotion desirably obtained by induction of an emotion of the human,
an anthropomorphic agent number calculation unit that calculates a number of anthropomorphic agents having an expression indicating the specific emotion, and
a video control unit that displays anthropomorphic agents having an expression indicating the specific emotion to the human by a number calculated by the anthropomorphic agent number calculation unit.

### Advantageous Effects of Invention

According to the disclosed technology, in a technology for inducing an emotion of a human to a target emotion by an anthropomorphic agent, easy induction to the target emotion can be enabled even in a case where the target emotion desirably obtained by induction and the emotion of the human are far from each other.

### BRIEF DESCRIPTION OF DRAWINGS

FIG. 1 is an overall configuration diagram of a system according to an embodiment of the present invention.

FIG. 2 is a configuration diagram of an emotion induction device according to the embodiment of the present invention.

FIG. 3 is a flowchart for describing operation of the emotion induction device.

FIG. 4 is a diagram illustrating an example of emotions on Russell's circumplex model of emotions.

FIG. 5 is a diagram illustrating an example of changing expressions of an anthropomorphic agent.

FIG. 6 is a diagram illustrating a hardware configuration example of a device.

### DESCRIPTION OF EMBODIMENTS

In the description below, an embodiment of the present invention (the present embodiment) will be described with reference to the drawings. The embodiment described below is merely an example, and an embodiment to which the present invention is applied is not limited to the embodiment described below.

### Overview of Embodiment

In the present embodiment, an emotion induction device 100 to be described below induces an emotion of a human to a target emotion desirably obtained by induction by displaying an anthropomorphic agent to the human.

Specifically, when expressing an expression of an anthropomorphic agent displayed to a human, the emotion induction device 100 estimates an emotion of the human and expresses an intermediate emotion between the emotion of the human and an emotion desirably obtained by induction by the anthropomorphic agent instead of expressing the emotion desirably obtained by induction. It is considered that the more the number of anthropomorphic agents making an expression desirably obtained by induction, the more easily a human is induced to the emotion, and thus, as an emotion of the human and the emotion desirably obtained by induction are far, the more the number of anthropomorphic agents making an expression of the emotion desirably obtained by induction (above intermediate emotion) is increased.

### Effects of Embodiment

As described above, a feeling of wrongness to an expression of an anthropomorphic agent is reduced when an intermediate emotion between an emotion of a human and an emotion desirably obtained by induction is expressed by the anthropomorphic agent, so that inducing the human to a target emotion is facilitated. As a result, for example, guiding an atmosphere to a calm atmosphere is facilitated when the place has a negative atmosphere in a video conference or the like, and thus, communication can be facilitated.

### (Example of System Configuration and Device Configuration)

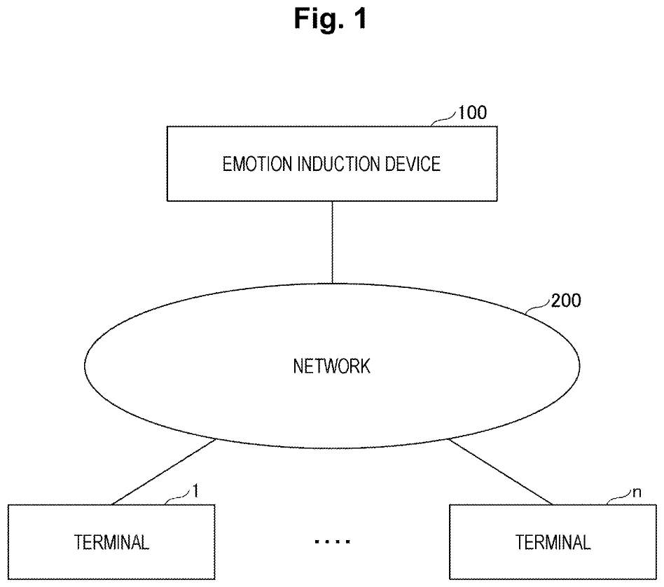

FIG. 1 illustrates an overall configuration example of a system according to the present embodiment. As illustrated in FIG. 1, the present system has a configuration in which the emotion induction device 100 and terminals 1 to n are connected to a network 200. The emotion induction device 100 is, for example, a device used as a server in a video conference. In the example of FIG. 1, there are n participants, and each of them performs communication from a terminal.

In the present embodiment, it is assumed that an anthropomorphic agent is displayed on each of the terminals 1 to n in a scene where communication by a video conference is performed. Note that n may be 2, or may be 2 or more. Furthermore, regarding a function of creating and displaying an anthropomorphic agent, each of the terminals may include a function of the emotion induction device 100 instead of including the emotion induction device 100 in the form of a server as illustrated in FIG. 1.

Each of the terminals includes a camera, and can capture a facial image of a human who uses the terminal and transmit the facial image to the emotion induction device 100.

Furthermore, the use of the emotion induction device 100 in communication by a plurality of persons as described above is an example, and the emotion induction device 100 may be used by an individual person to induce an emotion. For example, an anthropomorphic agent may be displayed to a human from the display of the emotion induction device 100, and the human may be induced to a desired emotion by viewing the anthropomorphic agent displayed on the display of the emotion induction device 100.

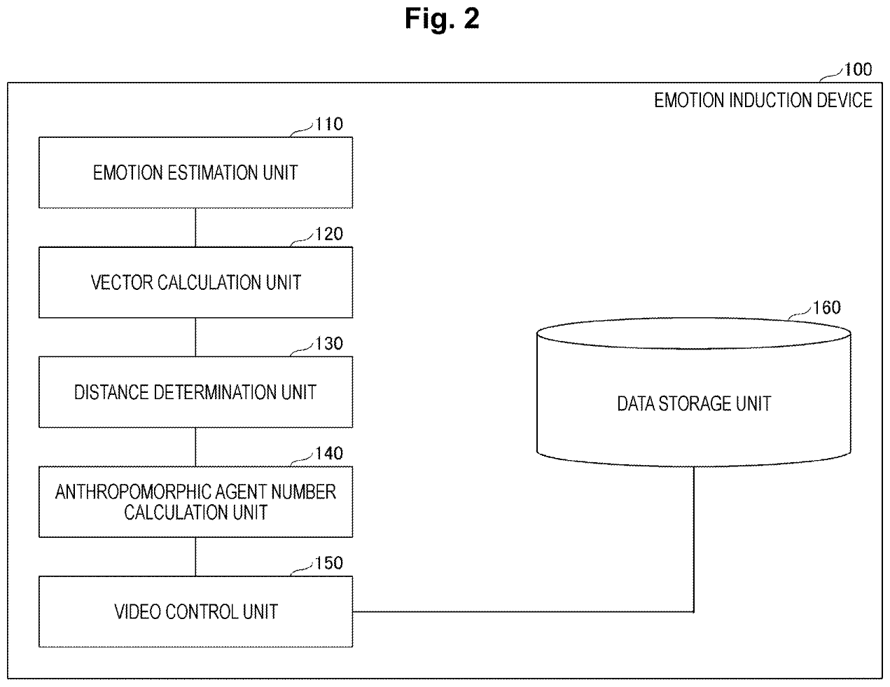

FIG. 2 illustrates a configuration example of the emotion induction device 100 according to the present embodiment. As illustrated in FIG. 2, the emotion induction device 100 includes an emotion estimation unit 110, a vector calculation unit 120, a distance determination unit 130, an anthropomorphic agent number calculation unit 140, a video control unit 150, and a data storage unit 160. Operation of each unit will be described in description of the operation with reference to a flowchart. Note that the vector calculation unit may be referred to as an emotion calculation unit. The distance determination unit may be referred to as a determination unit.

The emotion induction device 100 may be physically one device (computer), may have a configuration in which a plurality of computers is connected to a network, or may be a virtual machine on a cloud.

### (Operation Example of Emotion Induction Device 100)

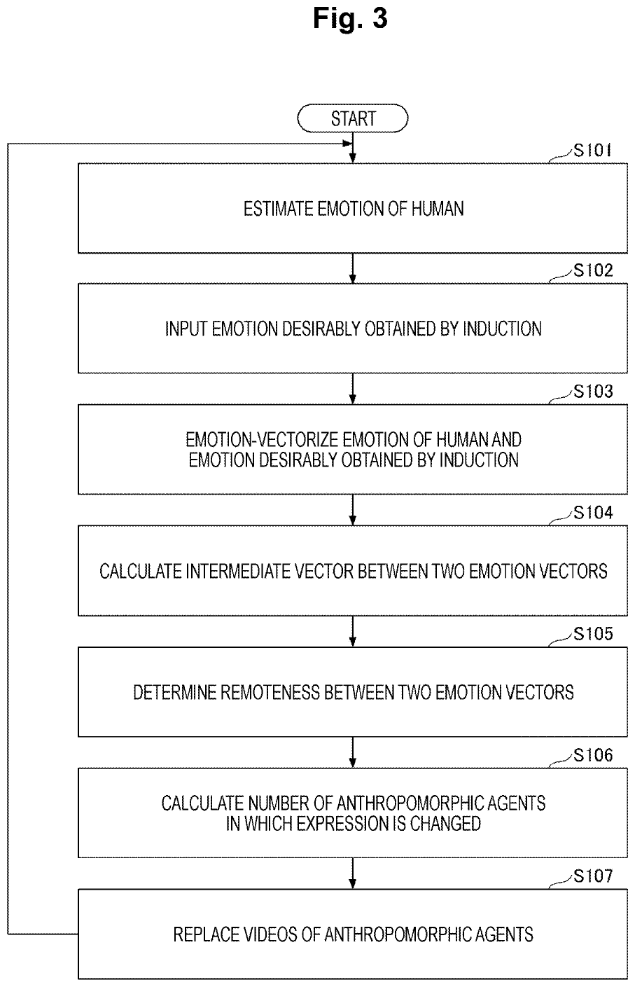

Next, an operation example of the emotion induction device 100 will be described in detail along a procedure of the flowchart illustrated in FIG. 3. Hereinafter, induction of an emotion in a case of focusing on a specific human will be described. The following “human” is that specific human. The specific human may be referred to as a “subject human”.

As a premise of the following processing, it is assumed that videos of anthropomorphic agents that make an expression corresponding to each emotion is stored in the data storage unit 160 in advance. Furthermore, the following processing is repeatedly performed, for example, at predetermined time intervals, and anthropomorphic agents making a certain expression are displayed on a terminal of the subject human.

### <S101>

In S101 (step 101), the emotion estimation unit 110 estimates an emotion of the human. Estimation itself of an emotion of a human can be implemented by an existing technology. A method of estimating an emotion of a human is not limited to a specific method, but for example, a technology of estimating an emotion from a facial image of a human (for example, “https://emotion-ai.userlocal.jp/face”) can be used. In this case, the emotion estimation unit 110 receives a facial image from the terminal of the human and estimates an emotion of the human from the facial image. The emotion may be estimated as, for example, any of “joy”, “anger”, “sorrow”, “surprise”, and “blankness”, or may be estimated as a value on Russell's circumplex model of emotions.

### <S102>

In S102, a target emotion to which the human is desired to be induced is input to the vector calculation unit 120. As the emotion desirably obtained by induction, for example, an emotion selected from emotions on Russell's circumplex model of emotions is input. The input of the emotion desirably obtained by induction may be performed from the terminal of the subject human or from another terminal (for example, terminal of a video conference organizer). A means for selecting an emotion on a terminal may be text input or touch input of an option.

Russell's circumplex model of emotions is a model in which emotions are mapped in a two-dimensional space in which the horizontal axis is the valence of pleasant-unpleasant and the vertical axis is the arousal level of awakening-drowsiness (Non Patent Literature 3).

### <S103>

In S103, the vector calculation unit 120 vectorizes each of the emotion of the human estimated in S101 and the emotion desirably obtained by induction input in S102. Vectors obtained by vectorizing emotions are called emotion vectors.

An emotion vector in the present embodiment is a vector on Russell's circumplex model of emotions. The vector calculation unit 120 vectorizes an emotion on the Russell's circumplex model of emotions using a direction from an origin to which the emotion is mapped on Russell's circumplex model of emotions as a vector direction.

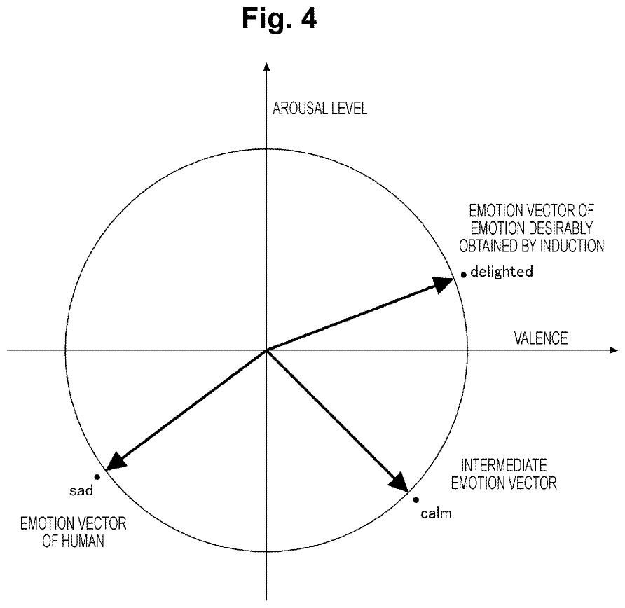

FIG. 4 illustrates an example of the emotion vectors on Russell's circumplex model of emotions. In the example illustrated in FIG. 4, each of the emotion vectors in a case where the estimated emotion of the human is “sad” and the emotion desirably obtained by induction is “delighted” is illustrated.

### <S104>

In S104, the vector calculation unit 120 calculates an intermediate vector that is an intermediate vector between an emotion vector of the emotion of the human and an emotion vector of the emotion desirably obtained by induction. In calculating the intermediate vector, for example, the idea of emotion vectors on Russell's circumplex model of emotions and resultant force in Non Patent Literature 4 may be used.

For example, the intermediate vector can be calculated as the sum of the emotion vector of the emotion of the human and the emotion vector of the emotion desirably obtained by induction. Furthermore, the intermediate vector may be calculated by multiplying the sum of the emotion vector of the emotion of the human and the emotion vector of the emotion desirably obtained by induction by a coefficient such that the magnitude of the intermediate vector is equal to or less than a certain value (for example, 1).

### <S105>

In S105, the distance determination unit 130 determines a distance (remoteness) between the emotion of the human and the emotion desirably obtained by induction by calculating the inner product of the emotion vector of the emotion of the human and the emotion vector of the emotion desirably obtained by induction. For example, the distance determination unit 130 determines that the distance between the emotion of the human and the emotion desirably obtained by induction is “far” in a case where the inner product obtained by calculation is less than 0, and determines that the distance is “close” in a case where the inner product is 0 or more. Note that, in a case where the magnitude of each of the emotion vectors is normalized to be 1 or less, the inner product determined as “far” is −1≤ inner product <0, and the inner product determined as “close” is 0≤inner product≤1.

### <S106>

In S106, the anthropomorphic agent number calculation unit 140 calculates the number of anthropomorphic agents each in which the expression of the anthropomorphic agent displayed for the subject human is changed to an expression of the emotion indicated by the intermediate vector calculated in S104 on the basis of the determination result in S105. This number is referred to as the “number of changed anthropomorphic agents”.

Basically, the number of anthropomorphic agents having the expression of the emotion indicated by the intermediate vector in a case where it is determined that the emotion of the human and the emotion desirably obtained by induction are far from each other is set larger than the number of anthropomorphic agents having the expression of the emotion indicated by the intermediate vector in a case where it is determined that the emotion of the human and the emotion desirably obtained by induction are close to each other.

For example, in a case where determination is made as “far”, the anthropomorphic agent number calculation unit 140 sets the number obtained by multiplying the value of an integer N times the absolute value (rounded down to the nearest whole number) of the inner product calculated in S105 by the number of humans participating in the video conference as the number of changed anthropomorphic agents. N is an integer of 2 or more, for example, 10. For example, when the number of participants is 3 and the absolute value of the inner product is 0.3, 0.3*10*3=9 is the number of changed anthropomorphic agents.

Furthermore, in a case where determination is made as “close”, the anthropomorphic agent number calculation unit 140 sets the number of changed anthropomorphic agents to the same number as the number of humans participating in the video conference. For example, in a case where three persons participate, the number of changed anthropomorphic agents is three.

### <S107>

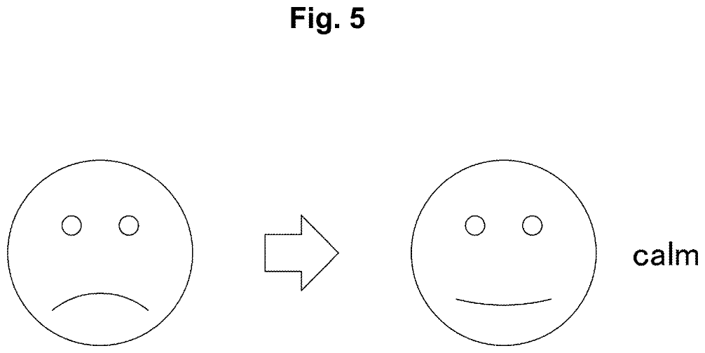

In S107, the video control unit 150 reads videos of anthropomorphic agents having the expression expressing the emotion of the intermediate vector from the data storage unit 160, and replaces videos of the number of anthropomorphic agents calculated in S106 with the videos of the anthropomorphic agents having the expression expressing the emotion of the intermediate vector for the anthropomorphic agents displayed on the terminal of the subject human. FIG. 5 illustrates an image of video replacement for one anthropomorphic agent.

In a case where the number of anthropomorphic agents already appearing on the screen of the terminal of the subject human is smaller than the number of changed anthropomorphic agents, the number of anthropomorphic agents is increased by, for example, displaying a new anthropomorphic agent on the screen.

### (Another Example)

In the emotion vector calculation described in S103, an emotion vector is defined on Russell's circumplex model of emotions, but this is an example. An emotion vector may be defined using an emotion model other than Russell's circumplex model of emotions. Furthermore, an emotion may be defined without using the concept of a “vector”.

Furthermore, although the index indicating an intermediate emotion between an emotion of a human and an emotion desirably obtained by induction described in S104 is calculated using the concept of an emotion vector in S104, the intermediate between the two (emotion of a human and emotion desirably obtained by induction) may be calculated by another index.

Furthermore, in S104, an intermediate emotion between two emotions is calculated, but the emotion may not be intermediate as long as the emotion is between two emotions. Furthermore, an emotion brought closer to an expression desirably obtained by induction may be calculated over time.

### (Hardware Configuration Example)

The emotion induction device 100 can be implemented by, for example, causing a computer to execute a program. This computer may be a physical computer, or may be a virtual machine on a cloud.

Specifically, the emotion induction device 100 can be implemented by executing a program corresponding to the processing to be performed in the emotion induction device 100, using hardware resources including a CPU and a memory installed in the computer. The program is recorded in a computer-readable recording medium (such as a portable memory) so that the program can be stored and distributed. The program can also be provided through a network such as the Internet or an electronic mail.

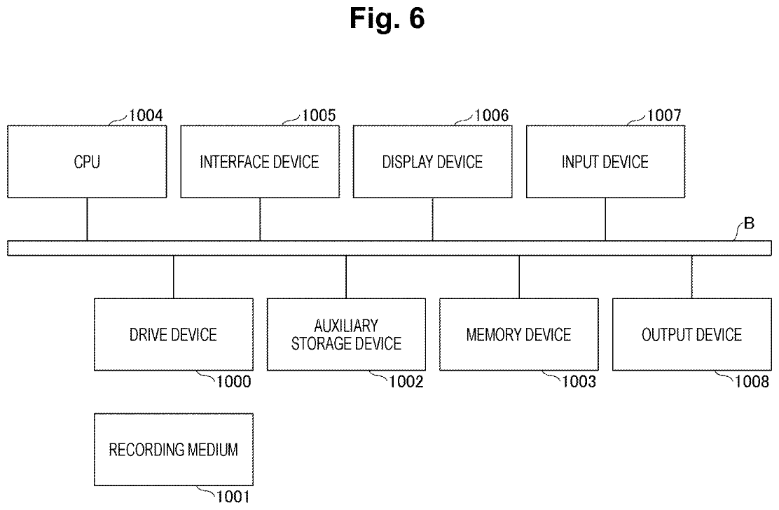

FIG. 6 is a diagram illustrating an example hardware configuration of the computer. The computer in FIG. 6 includes a drive device 1000, an auxiliary storage device 1002, a memory device 1003, a CPU 1004, an interface device 1005, a display device 1006, an input device 1007, and an output device 1008, which are connected to one another by a bus B.

The program for implementing the processing in the computer is provided by, for example, a recording medium 1001 such as a CD-ROM or a memory card. When the recording medium 1001 that stores the program is set in the drive device 1000, the program is installed from the recording medium 1001 into the auxiliary storage device 1002 via the drive device 1000. However, the program is not necessarily installed from the recording medium 1001, and may be downloaded from another computer via a network. The auxiliary storage device 1002 stores the installed program and also stores necessary files, data, and the like.

In a case where it is instructed to activate the program, the memory device 1003 reads and stores the program from the auxiliary storage device 1002. The CPU 1004 implements a function related to the emotion induction device 100 in accordance with the program stored in the memory device 1003. The interface device 1005 is used as an interface for connection to a network or the like. The display device 1006 displays a graphical user interface (GUI) or the like according to the program. The input device 1007 includes, for example, a keyboard, a mouse, buttons and a touchscreen, and is used to input various operation instructions. The output device 1008 outputs a computation result.

### Summary of Embodiment

The present description discloses an emotion induction device, an emotion induction method, and a program in at least the following clauses.

### (Clause 1)

An emotion induction device that displays an anthropomorphic agent to a human, the emotion induction device including
an emotion estimation unit that estimates an emotion of the human,
an emotion calculation unit that calculates a specific emotion that is an emotion between an emotion of the human and an induction target emotion that is a target emotion desirably obtained by induction of an emotion of the human,
an anthropomorphic agent number calculation unit that calculates a number of anthropomorphic agents having an expression indicating the specific emotion, and
a video control unit that displays anthropomorphic agents having an expression indicating the specific emotion to the human by a number calculated by the anthropomorphic agent number calculation unit.

### (Clause 2)

The emotion induction device according to the clause 1 further including a determination unit that determines remoteness between an emotion of the human and the induction target emotion,
in which the anthropomorphic agent number calculation unit performs calculation such that a number of anthropomorphic agents having an expression indicating the specific emotion in a case where an emotion of the human and the induction target emotion are far from each other is larger than a number of anthropomorphic agents having an expression indicating the specific emotion in a case where an emotion of the human and the induction target emotion are close to each other.

### (Clause 3)

The emotion induction device according to the clause 1 or 2,
in which the emotion calculation unit calculates the specific emotion by calculating an intermediate vector between an emotion vector indicating an emotion of the human and an emotion vector indicating the induction target emotion.

### (Clause 4)

An emotion induction method performed by an emotion induction device that displays an anthropomorphic agent to a human, the emotion induction method including
an emotion estimation step of estimating an emotion of the human,
an emotion calculation step of calculating a specific emotion that is an emotion between an emotion of the human and an induction target emotion that is a target emotion desirably obtained by induction of an emotion of the human,
an anthropomorphic agent number calculation step of calculating a number of anthropomorphic agents having an expression indicating the specific emotion, and
a step of displaying anthropomorphic agents having an expression indicating the specific emotion to the human by a number calculated by the anthropomorphic agent number calculation step.

### (Clause 5)

A program for causing a computer to function as each unit in the emotion induction device according to any one of the clauses 1 to 3.

Although the present embodiment has been described above, the present invention is not limited to such a specific embodiment, and various modifications and changes can be made within the scope of accompanying claims.

### REFERENCE SIGNS LIST

1 to n Terminal
100 Emotion induction device
110 Emotion estimation unit
120 Vector calculation unit
130 Distance determination unit
140 Anthropomorphic agent number calculation unit
150 Video control unit
160 Data storage unit
200 Network
1000 Drive device
1001 Recording medium
1002 Auxiliary storage device
1003 Memory device
1004 CPU
1005 Interface device
1006 Display device
1007 input device

1. An emotion induction device comprising:
circuitry configured to:
estimate a human emotion;
determine a specific emotion that is an emotion between the human emotion and a target emotion that is obtained by inducing the human emotion;
determine a number of anthropomorphic agents having an expression indicating the specific emotion; and
display the determined number of anthropomorphic agents having the expression to a human.

2. The emotion induction device according to claim 1, wherein the circuitry is configured to:
determine a distance between the human emotion and the target emotion,
determine a first number of anthropomorphic agents having the expression to be greater than a second number of anthropomorphic agents having the expression, the first number of anthropomorphic agents being obtained upon determining that the distance between the human emotion and the target emotion is greater than or equal to a threshold, and the second number of anthropomorphic agents being obtained upon determining that the distance between the human emotion and the target emotion is less than the threshold.

3. The emotion induction device according to claim 1, wherein the circuitry is configured to calculate an intermediate vector between an emotion vector indicating the human emotion and an emotion vector indicating the target emotion.

4. An emotion induction method performed by an emotion induction device, the emotion induction method comprising:
estimating a human emotion;
determining a specific emotion that is an emotion between the human emotion and a target emotion that is obtained by inducing the human emotion;
determining a number of anthropomorphic agents having an expression indicating the specific emotion; and
displaying the determined number of anthropomorphic agents having the expression to a human.

5. A non-transitory computer readable medium storing a program for causing a computer to execute the emotion induction method of claim 4.
